(19) United States
(12) Patent Application Publication
(10) Pub. No.: US 2007/0110427 A1
(43) Pub. Date: May 17, 2007

(54) Method of exposure compensation

(76) Inventor: Hung-Chi Tsai, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/560,815

(22) Filed: Nov. 16, 2006

(30) Foreign Application Priority Data
Nov. 17, 2005 (TW) 094140500

(51) Int. Cl. G03B 9/70

(52) U.S. Cl. 396/166

(57) ABSTRACT

A method of exposure compensation comprises capturing a first image without a flash, capturing a second image with the flash, generating a F-number, a shutter speed value, and a flash value according to brightness distribution of the first and second images, and capturing a third image according to the F-number, the shutter speed value, and the flash value.

### BACKGROUND OF THE INVENTION

1. Field of the Invention

The invention relates to exposure compensation, and in particular to method of exposure compensation in a camera.

2. Description of the Prior Art

Generally, color and brightness of a background may cause an incorrect exposure in photography. For example, when using the center weighted averaging metering function of a camera, a background of light color or high brightness may result in a captured image with under-exposed background due to the camera misjudging the exposure, for example, the original white background registering as gray. Similarly, a background of dark color or low brightness can result in a captured image with overexposed background, for example, an original black background registering as gray.

A conventional method of exposure compensation to address the above problem adjusts the overall brightness of the subject. Namely, the foreground and the background are adjusted at the same time, to be lighter or darker. This method, however, while correcting the exposure of the background, can inaccurately expose the foreground. Accordingly, some multi-featured cameras utilize flash compensation to overcome the problem, although this requires the two compensation methods to cooperate.

This cooperative solution can be complicated and difficult to use, causing inconvenience for users.

### SUMMARY OF THE INVENTION

It is therefore a primary objective of the invention to provide a method of exposure compensation to solve the above-mentioned problems.

The invention discloses a method of exposure compensation, comprising capturing a first image without a flash, capturing a second image with the flash, generating a F-number, a shutter speed value, and a flash value according to brightness distribution of the first and second images, and capturing a third image according to the F-number, the shutter speed value, and the flash value.

These and other objectives of the invention will no doubt become obvious to those of ordinary skill in the art after reading the following detailed description of the preferred embodiment that is illustrated in the various figures and drawings.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a camera of the invention in use.

FIG. 2 is a schematic diagram of a first image captured by the camera of the invention without a flash.

FIG. 3 is a schematic diagram of a second image captured by the camera of the invention using a flash.

FIG. 4 is a flowchart of a method of exposure compensation of the invention.

### DETAILED DESCRIPTION

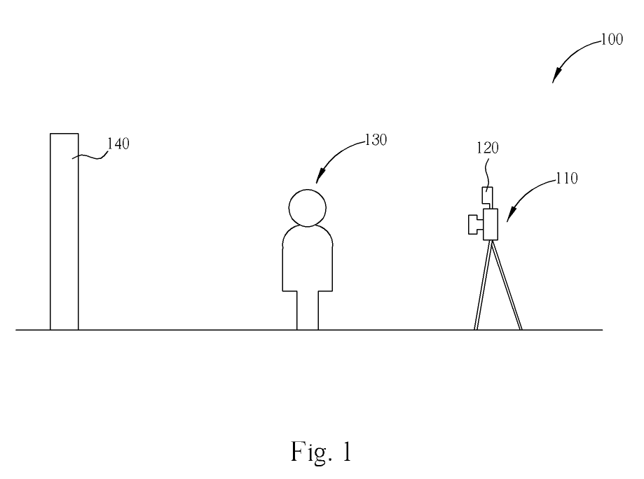

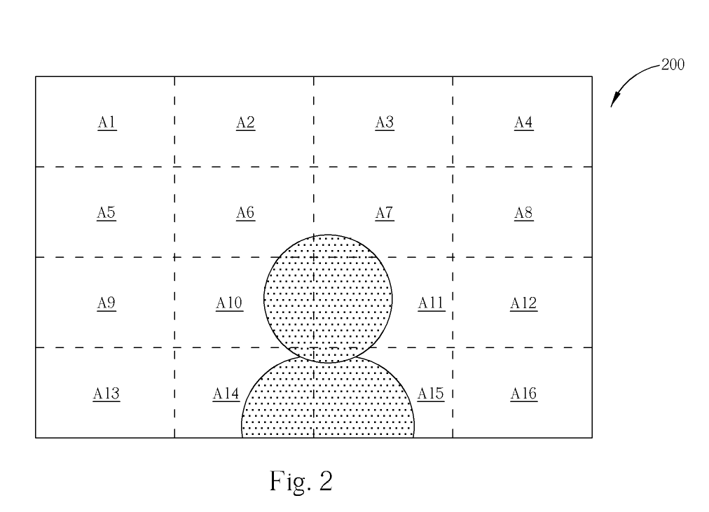

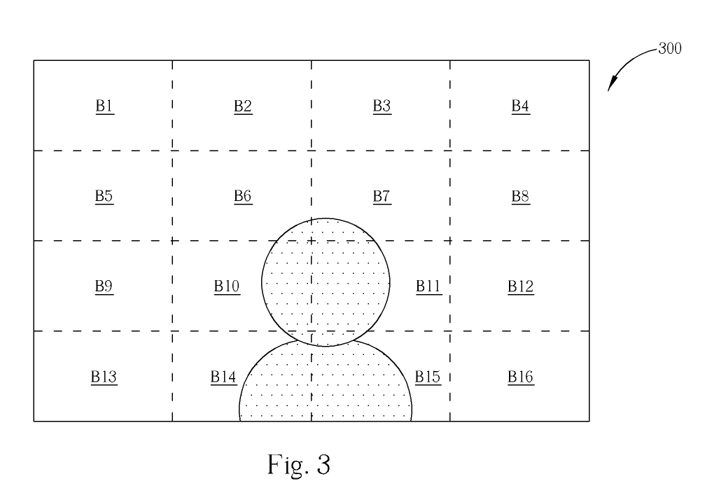

FIG. 1 is a schematic diagram of a camera 100 of the invention during use. FIG. 2 depicts a first image 200 captured by the camera 100 without a flash 120. FIG. 3 depicts a second image 300 captured by the camera 100 with the flash 120. First, the camera 110 captures the first image 200 without the flash 120. The first image 200 is divided into a plurality of areas, such as sixteen areas A1˜A16, and the brightness of each area is calculated. Next, the camera 110 captures the second image 300 with the flash 120. The second image 300 is also divided into a plurality of areas, such as sixteen areas B1˜B16, and the brightness of each area is calculated. In this embodiment, the F-number and the shutter speed value are the same when capturing the first image 200 and the second image 300. In another embodiment, the F-number and the shutter speed value may be different when capturing the first image 200 and the second image 300. The brightness of each area A1˜A16 of first image 200 minus the brightness of each area B1˜B16 of first image 200 leaves flash contributing values L_{flash}_{_{—}}ₙ of each area. A flash contributing value L_{flash} is the sum of each flash contributing values L_{flash}_{_{—}}ₙ. Here, n indicates each area. In this embodiment, n is 1 to 16. Calculation of flash contributing values L_{flash}_{_{—}}ₙ is as follows:
L_{flash}_{_{—}}ₙ=L_{Bn}−L_{An} formula (1)

When flash 120 of the camera 110 is used, exposure enhancement of the background 140 is less than that of the foreground 130 because the background 140 is further from the camera 110. Therefore, when one of the flash contributing values L_{flash}_{_{—}}ₙ is less than a threshold value L_{thd}, the area indicates the background. Otherwise, when one of the flash contributing values L_{flash}_{_{—}}ₙ exceeds a threshold value L_{thd}, the area indicates the foreground. The threshold value L_{thd} is decided automatically by the camera 110 itself or by the user. Thus, the foreground and the background of the capturing environment 100 are distinguished according to the flash contributing values L_{flash}_{_{—}}ₙ. In this embodiment, foreground comprises areas with n of 6, 7, 10, 11, 14 and 15, and background comprises areas with n of 1˜5, 8˜9, 12˜13 and 16, shown in FIGS. 2 and 3. Although, the first image 200 and the second image 300 are divided into sixteen areas in this embodiment, more areas can be utilized to increase accuracy.

After the foreground and the background of the capturing environment 100 are distinguished, a compensation F-number Fn_{c} and a compensation shutter speed value Exp_{c} are generated according to the average brightness LA_{bg} of the background. More specifically, an environmental brightness LV calculated according to the average brightness LA_{bg} generates the compensation F-number Fn_{c} and compensation shutter speed value Exp_{c}. However, another environmental brightness LV may be calculated according to the average brightness LB_{bg} to generate the compensation F-number Fn_{c} and compensation shutter speed value Exp_{c}. Calculation of environmental brightness LV is as follows:
LV=Log₂[(Fn²×LA_{bg})/(Exp×L_{target})] formula (2)

In formula (2), Fn and Exp indicate the F-number and the shutter speed value when capturing the first image 200. L_{target} indicates the normal exposure recognized by the camera 110, varying with circumstance. Next, the compensation F-number Fn_{c} and compensation shutter speed value Exp_{c} are generated according to environmental brightness LV. Calculation of compensation F-number Fn_{c} and compensation shutter speed value Exp_{c} is as follows:
LV+EV_{bias}=log₂(Fn_{c}²/Exp_{c}) formula (3)

In formula (3), EV_{bias} indicates that exposure of the background requires adjustment, and may vary with circumstance. Thus, the generated compensation F-number Fn_{c} and compensation shutter speed value Exp_{c} compensate the exposure of the background to achieve expected results. Multiple sets of compensation F-number Fn_{c} and compensation shutter speed value Exp_{c} can be calculated from formula (3). Camera 110 or the user chooses a compensation F-number Fn_{c}, and the corresponding compensation shutter speed value Exp_{c} is calculated, or a compensation shutter speed value Exp_{c} is chosen to calculate the corresponding compensation F-number Fn_{c}.

When the compensation F-number Fn_{c} and the compensation shutter speed value Exp_{c} are generated, a compensation flash value S_{c} is generated according to the average brightness of the foreground, the compensation F-number Fn_{c}, the compensation shutter speed value Exp_{c}, and the flash contributing value L_{flash}. More specifically, a new average brightness of the foreground L_{fg}_{_{—}}_{new} and a new flash contributing value L_{flash}_{_{—}}_{new} are calculated, and the compensation flash value S_{c} is then calculated accordingly. Calculation of the new average brightness of the foreground L_{fg}_{_{—}}_{new} is as follows:
L_{fg}_{_{—}}_{new}=LA_{fg}×[(Fn²×Exp_{c})/(Fn_{c}²×Exp)] formula (4)

In formula (4), Fn and Exp indicate the used F-number and shutter speed value when capturing the first image 200. The LA_{fg} indicates the average brightness of foreground in the first image 200. In this embodiment, the L_{fg}_{_{—}}_{new} is calculated according to the LA_{fg}, however, it can also be calculated according to a LB_{fg} which indicates an average brightness of background in the first image 200.

Otherwise, calculation of a new flash contributing value L_{flash}_{_{—}}_{new} is as follows:
L_{flash}_{_{—}}_{new}=L_{flash}×(Fn²×Fn_{c}²) formula (5)

After the new average brightness of the foreground L_{fg}_{_{—}}_{new} and the new flash contributing value L_{flash}_{_{—}}_{new} are calculated, the compensation flash value S_{c} is generated. Calculation of the compensation flash value S_{c} is as follows:
S_{c}=S×[(L_{target}−L_{fg}_{_{—}}_{new})/L_{flash}_{_{—}}_{new}] formula (6)

In formula (6), S indicates the flash value when capturing the second image 300.

With formulae (1) to (6), the camera 110 of the invention utilizes the generated compensation F-number Fn_{c}, the compensation shutter speed value Exp_{c}, and the compensation flash value S_{c} to shoot a third image with correct exposure in foreground and background.

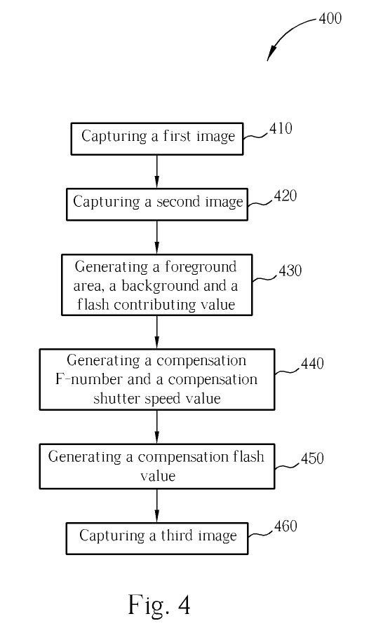

FIG. 4 is a flowchart 400 of the method of the invention.

In step 410, a first image is generated without using a flash.

In step 420, a second image is generated with a flash.

In step 430, a foreground area, a background area and a flash contributing value L_{flash} are generated according to brightness of each area of the first image 200 and the second image 300.

In step 440, a compensation F-number Fn_{c} and a compensation shutter speed value Exp_{c} are generated according to the average brightness of the background.

In step 450, a compensation flash value S_{c} is generated according to the compensation F-number Fn_{c}, the compensation shutter speed value Exp_{c}, and the flash contributing value L_{flash}.

In step 460, a third image is generated according to the compensation F-number Fn_{c}, the compensation shutter speed value Exp_{c}, and the compensation flash value S_{c}.

The steps may follow the above sequence, or alternatively, may vary with circumstance. Other steps may be inserted into the process. The method of the invention can be executed by software, firmware, hardware, or combinations thereof.

As mentioned, a first image 200 and a second image 300 are captured to generate the compensation F-number Fn_{c}, the compensation shutter speed value Exp_{c}, and the compensation flash value S_{c} so that a third image is captured with accurate foreground and background exposure. The procedure may executed by a camera (such as a digital camera) 110 during a predetermined period. The exposure compensation of the foreground and the background is automatically adjusted according to the exposure of the background (via choosing a EV_{bias}) such that the method of the exposure compensation is easily employed.

The invention provides a method of exposure compensation utilized for capturing an image by a camera with a flash, such that the captured picture has accurate foreground and background exposure, and the conventional flash compensation and method of exposure compensation are not required. Thus, the invention is more convenient and easily used than conventional methods.

While the invention has been described by way of example and in terms of a preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of exposure compensation comprising:
(a) capturing a first image without a flash;
(b) capturing a second image with a flash;
(c) generating a F-number, a shutter speed value, and a flash value according to a brightness distribution of the first image and a brightness distribution of the second image;
(d) capturing a third image according to the F-number, the shutter speed value, and the flash value.

2. The method of claim 1, further comprising generating a flash contributing value and a foreground area and a background area of a subject environment according to the brightness distributions of the first and second images, wherein the F-number and the shutter speed value are generated according to an average brightness of the background area.

3. The method of claim 2, wherein the flash value is generated according to an average brightness of the foreground area, the F-number, the shutter speed value and the flash contributing value.

4. The method of claim 1, wherein the F-number and the shutter speed value are the same in the step (a) and step (b).

5. The method of claim 1, wherein the method is utilizing a digital camera during image capture.

6. The method of claim 1, wherein step (a) to the step (d) are executed in a predetermined period.
